(19) United States
(12) Patent Application Publication
(10) Pub. No.: US 2002/0145390 A1
(43) Pub. Date: Oct. 10, 2002

(54) Discharge cells between barrier walls of alternating current discharge type plasma display panel

(76) Inventors: Shiuh-Bin Kao, Taipei (TW); Yi-Sheng Yu, Taipei (TW); Ching-Hui Lin, Taipei (TW); Kuang-Lang Chen, Taipei (TW); Sheng-Chi Lee, Taipei (TW)

Correspondence Address: BACON & THOMAS, PLLC, 625 SLATERS LANE, FOURTH FLOOR, ALEXANDRIA, VA, 22314

(21) Appl. No.: 09/870,786

(22) Filed: Jun. 1, 2001

(30) Foreign Application Priority Data
Apr. 6, 2001 (TW) 090108269

(51) Int. Cl. G09G 3/10

(52) U.S. Cl. 315/169.3; 315/169.4

(57) ABSTRACT

In an alternating current discharge type plasma display panel (PDP) a plurality of parallel barrier walls are formed on top surface of a back substrate of the PDP and barrier walls are disposed corresponding to cross-points of X electrodes and Y electrodes on a front substrate the PDP. A structure comprises a plurality of discharge cells between the adjacent barrier walls having smaller width corresponding to the X and Y electrodes for forming a large first space, a plurality of non-discharge cells each between the adjacent discharge cells for forming a small second space served as a gas channel between the adjacent discharge cells, and a junction between one discharge cell and the adjacent non-discharge cell, whereby energy released from a gas discharge in the discharge cells is concentrated within the discharge cells for increasing discharge efficiency.

### FIELD OF THE INVENTION

The present invention relates to plasma display panels (PDPs) and more particularly to a structure of discharge cells between barrier walls of alternating current discharge type PDP with improved characteristics.

### BACKGROUND OF THE INVENTION

A manufacturing process of a conventional alternating current discharge type plasma display panel (PDP) 10 is shown in FIG. 1. First, two different activation layers are formed on glass substrates 11 and 12 respectively. Then seal the peripheries thereof. A mixed gas consisting of helium (He), neon (Ne), and xenon (Xe) (or argon (Ar)) having a predetermined mixing volume ratio is stored in a discharge space therein. A front substrate 11 is defined as one that facing viewers. A plurality of parallel transparent electrodes 111, a plurality of bus electrodes 112, a dielectric layer 13, and a protective layer 14 are formed from the front substrate 11 inwardly. Correspondingly, from rear substrate 12 inwardly, a plurality of parallel data electrodes 121, a dielectric layer 124, a plurality of parallel spacer walls 122, and a uniform phosphor layer 123 are formed. When a voltage is applied on electrodes 111, 112, and 121, dielectric layers 113 and 124 will discharge on discharge cell 13 formed by adjacent barrier walls 122. As a result, a ray having a desired color is emitted from phosphor layer 123.

Conventionally, in PDP 10 a plurality of parallel transparent electrodes 111 are formed on inner surface of front substrate 11 by sputtering and photolithography (or printing). Then a plurality of bus electrodes 112 are formed on the transparent electrodes 111 by plating (or sputtering) and photolithography. The line impedance of the transparent electrodes 111 may be reduced by the provision of bus electrodes 112. In the following description, two adjacent transparent electrodes 111 (including bus electrodes 112) on the front substrate 11 are represented by X electrode and Y electrode respectively. A triple electrode is formed by X electrode, Y electrode and corresponding data electrode 121 on the rear substrate 12. When a voltage is applied on the triple electrode, dielectric layers 113 and 124 will discharge on discharge cell 13 formed by adjacent spacer walls 122. Hence, UV rays are emitted from the mixed gas stored therein. And in turn, phosphor layer 123 in discharge cell 13 is excited by the UV rays. As an end, a visible light is generated by red, green and blue phosphor layers, resulting in an image showing.

As shown in FIGS. 1 and 2, a plurality of parallel barrier walls 122 are provided on back substrate 12. A plurality of parallel data electrodes 121 are provided on the underside of dielectric layer 124. Barrier walls 122 and data electrodes 121 are alternate, while barrier walls 122 are atop data electrodes 121. A discharge cell 13 is formed between two adjacent barrier walls 122. A phosphor layer 123 is coated on discharge cell 13, opposite walls of barrier wall 122, and dielectric layer 124 respectively. However, several drawbacks have been found as detailed below:

(a) The coating area of phosphor layer 123 is small: In view of back substrate 12, phosphor layer 123 is only allowed to be coated on discharge cell 13, opposite walls of barrier wall 122, and dielectric layer 124 respectively. This may lowers emissivity of PDP 10.

(b) Discharge area is small: Referring to FIG. 3, there is shown a sectional view of adjacent discharge cells 13 with a suitable distance D formed therebetween in the conventional alternating current type PDP 10. Such distance D is provided for avoiding an undesired discharge. However, the provision of distance D may narrow the discharge cells 13 (i.e., opening too narrow), resulting in a lowering of emissivity. To the contrary, a small non-discharge cell may provide a large discharge space for obtaining an increased emissivity. However, this may also tend to cause undesired discharge which in turn has an adverse effect on the adjacent discharge cell.

(c) Subject to undesired discharge: Referring to FIG. 4, there is shown two adjacent discharge regions A and a sandwiched non-discharge region B in the conventional alternating current type PDP 10. It is seen that there is no barrier between two adjacent discharges regions A. Hence, it is subject to undesired discharge in non-discharge region B.

(d) Additional processing required: Referring to FIG. 5, there is shown two adjacent discharge regions A, a sandwiched non-discharge region B, and a hatched region C. The hatched region C is where an additional processing on non-discharge region is performed for blocking light emitted from non-discharge region B, thereby obtaining a strong contrast of image shown on PDP 10.

A number of proposals regarding the structure of barrier wall have been submitted by PDP designers and manufacturers for solving above drawbacks. For example, Pioneer Company (Japan) discloses a waffle-like barrier wall 622 as shown in FIG. 6. Phosphor layer is coated on top, bottom, left, right, and underside of discharge cell respectively. Hence, coating area of phosphor layers is increased, resulting in an increase of emissivity. Also, discharge cell is enclosed for eliminating the undesired discharge of non-discharge region. However, such enclosed discharge cell may increase difficulty of vacuum and gas filling. Another design is disclosed by Fujitsu Company (Japan) wherein barrier wall 722 has a meander rib structure as shown in FIG. 7. Such structure can increase the coating area to a maximum. However, this design suffered from several disadvantages. For example, phosphor layer printing is difficult in the process. As a result, color tends to mix. Further, uniformity of phosphor layer printing is not obtainable. This in turn increases manufacturing cost and difficulty. To the worse, yield is lowered. Moreover, back substrate manufactured by such technique is not conformed to front substrate. Hence, a specifically designed front substrate is required. As to drive technique, conventional drive techniques are not applicable if a complex drive technique such as ALIS is not adopted in conjunction therewith. In brief, despite of maximum coating area obtained such design proposed by Fujitsu Company is still disadvantageous due to problems associated with manufacturing process and drive technique.

### SUMMARY OF THE INVENTION

It is thus an object of the present invention in an alternating current discharge type plasma display panel (PDP), a plurality of parallel barrier walls formed on top surface of a back substrate of the PDP, the barrier walls being disposed corresponding to cross-points of X electrodes and Y electrodes on a front substrate the PDP, a structure comprising a plurality of discharge cells between the adjacent barrier walls having smaller width corresponding to the X and Y electrodes for forming a large first space, a plurality of non-discharge cells each between the adjacent discharge cells for forming a small second space served as a gas channel between the adjacent discharge cells, and a junction having a predetermined shape between one discharge cell and the adjacent non-discharge cell, whereby energy released from a gas discharge in the discharge cells is concentrated within the discharge cells for increasing discharge efficiency, emissivity, avoiding undesired gas discharge, and achieving a smooth vacuum and gas filling during the manufacturing process of PDP.

The above and other objects, features and advantages of the present invention will become apparent from the following detailed description taken with the accompanying drawings.

### BRIEF DESCRIPTION OF THE DRAWINGS

FIG. 1 is a sectional view of a conventional alternating current discharge type PDP;

FIG. 2 is a perspective view of FIG. 1 PDP;

FIG. 3 is sectional view showing adjacent discharge cells of FIG. 2;

FIG. 4 is a view similar to FIG. 3 showing two adjacent discharge regions and a sandwiched non-discharge region;

FIG. 5 is a view similar to FIG. 3 showing adjacent discharge regions, a sandwiched non-discharge region, and a hatched region within non-discharge region;

FIG. 6 is a perspective view showing a waffle-like barrier wall of a conventional design;

FIG. 7 is a perspective view showing a meander rib-like barrier wall of another conventional design;

FIG. 8 is a perspective view of a back substrate and other associated elements of alternating current discharge type PDP according to the invention;

FIG. 9 is a schematic top plan view of back substrate of FIG. 8; and

FIG. 10 is a view similar to FIG. 9 where X electrodes and Y electrodes are shown.

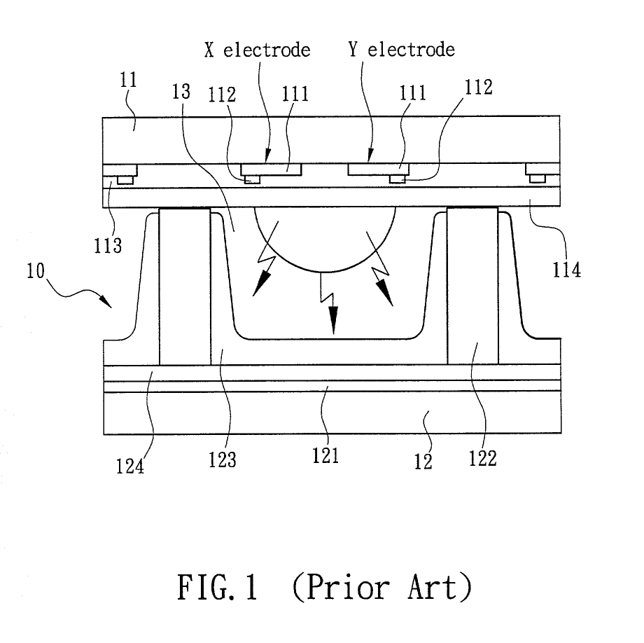

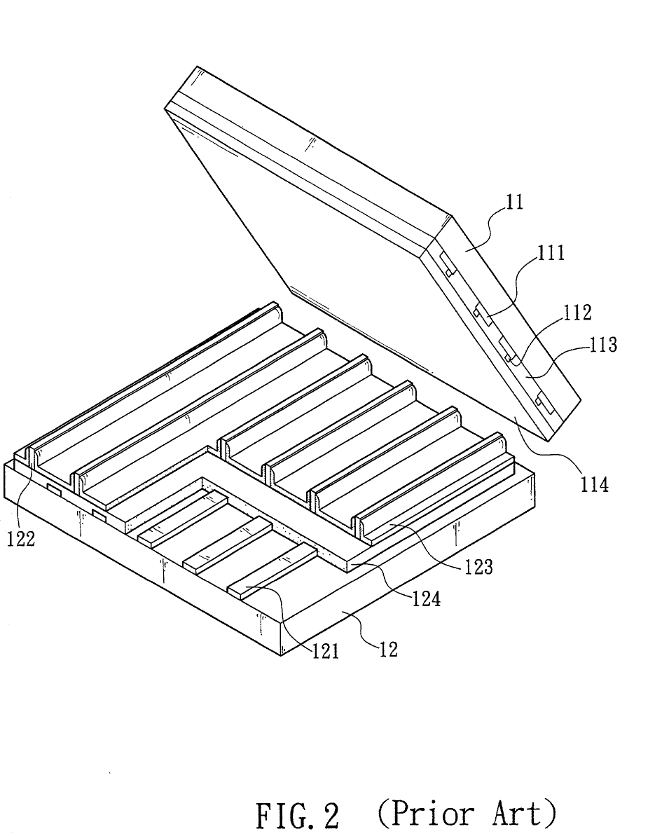

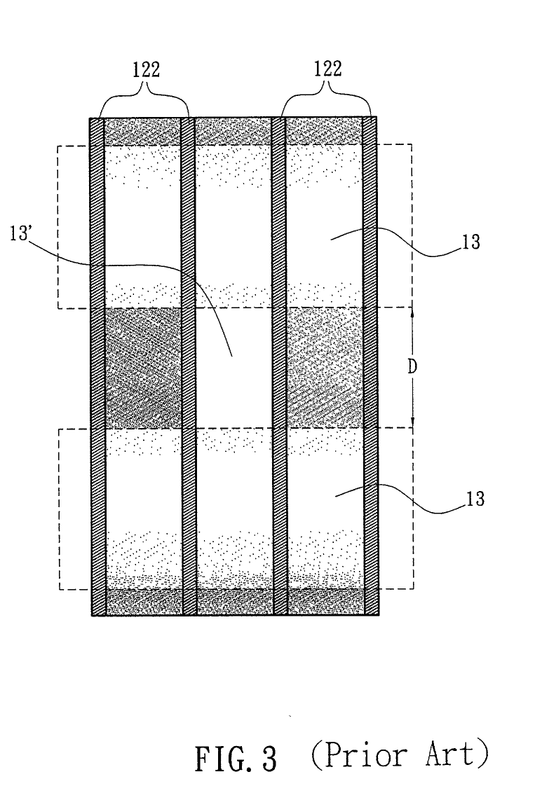

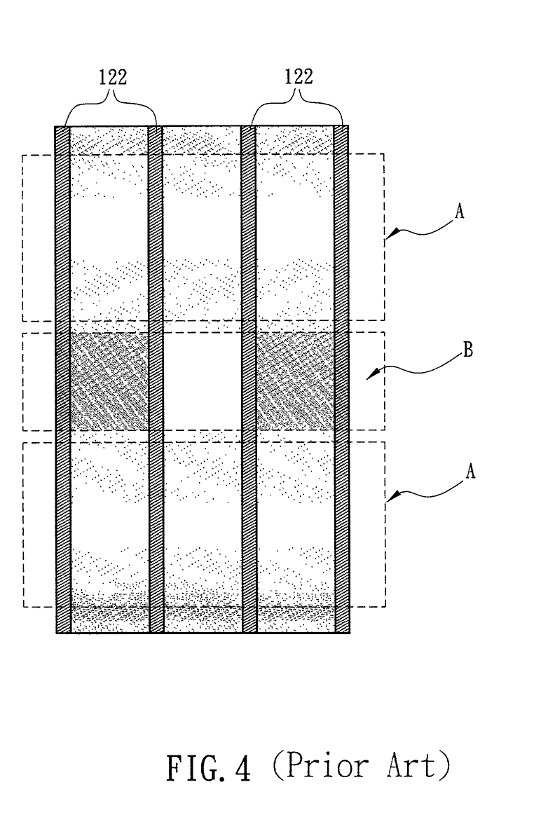

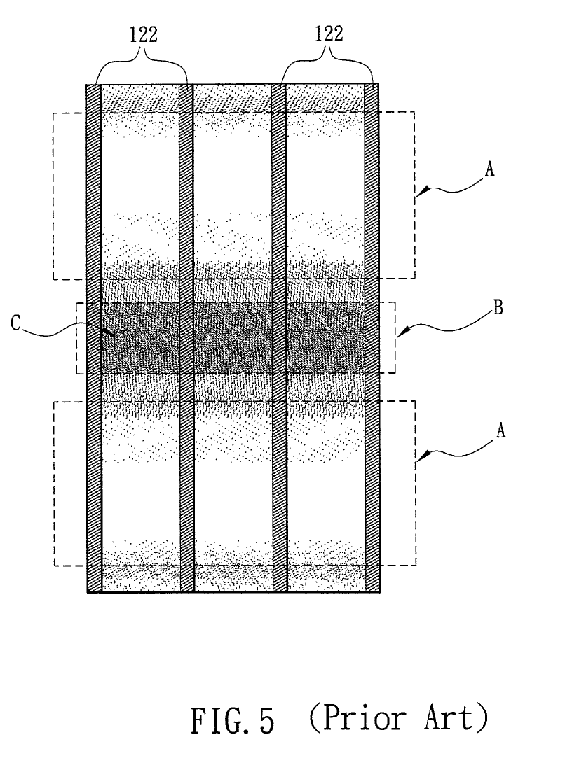

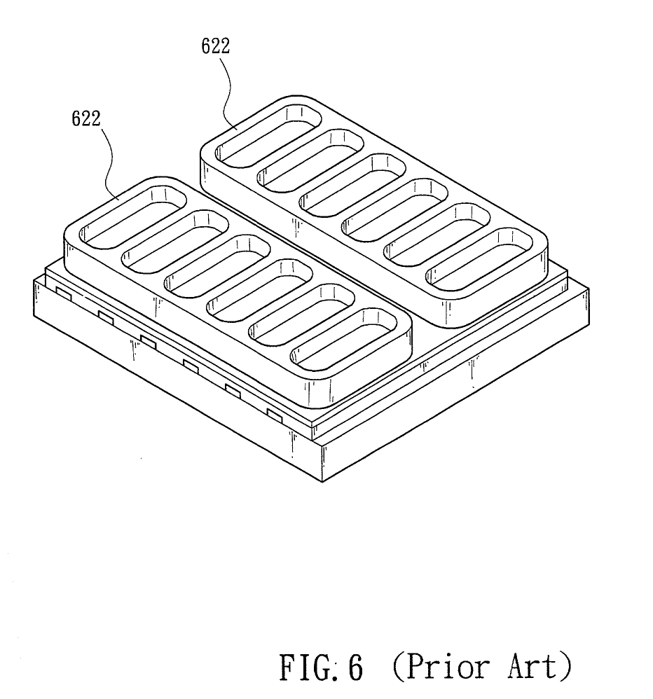

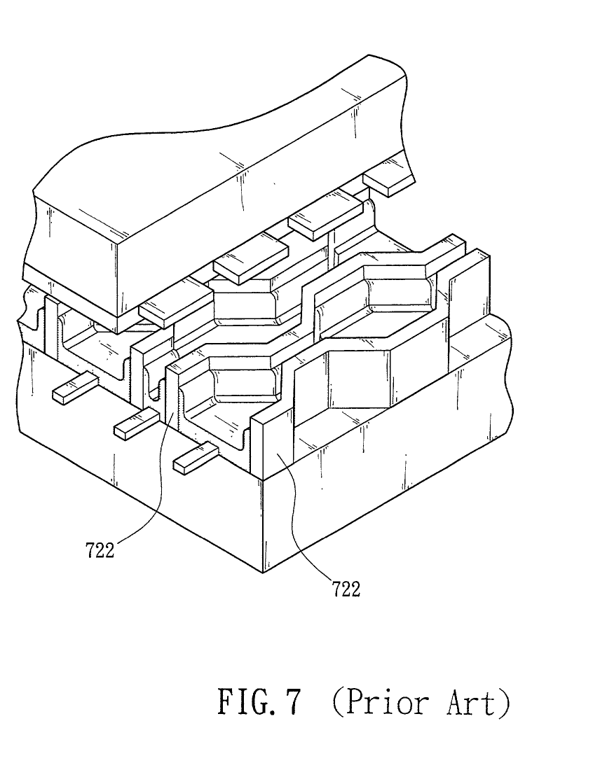

### DETAILED DESCRIPTION OF THE PREFERRED EMBODIMENTS

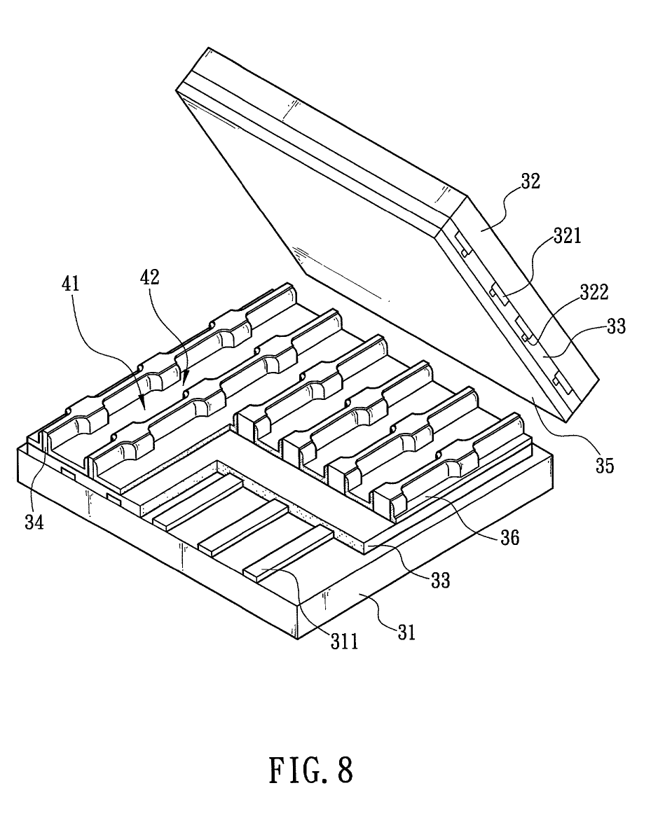

Referring to FIG. 8, there is shown a back substrate 31 and other associated elements of alternating current discharge type PDP in accordance with the invention. As shown, a plurality of parallel data electrodes 311 are formed on back substrate 31. A dielectric layer 33 is formed on data electrodes 311. A plurality of parallel barrier walls 34 are formed on dielectric layer 33. Barrier walls 34 and data electrodes 311 are alternate, while barrier walls 122 are atop data electrodes 311. On the bottom surface of front substrate 32, a plurality of parallel transparent electrodes 321 each including an bus electrode 322 (e.g., X electrode or Y electrode) are formed. A dielectric layer 33 is formed on the electrodes. A protective layer 35 is printed on dielectric layer 33. Further, secure back substrate and front substrate together. Then make a vacuum and fill neon and xenon gases to mix therein. Data electrodes 311 on back substrate 31 and transparent electrodes 321 on front substrate 32 are disposed horizontally and vertically on PDP respectively. In other words, data electrodes 311 and transparent electrodes 321 are perpendicular each other, thus forming a plurality of discharge cells 41 therein.

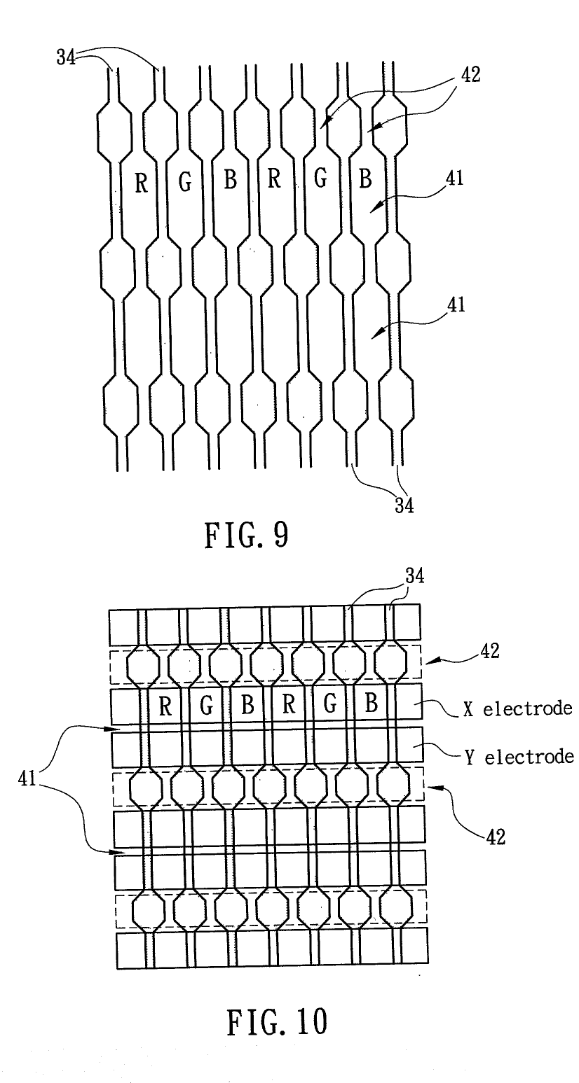

Referring to FIGS. 9 and 10, the configuration on top of back substrate 31 is shown. A plurality of parallel barrier walls 34 are disposed corresponding to cross-points of X electrodes and Y electrodes on front substrate 32. In detail, a plurality of discharge cells 41 are formed in wider areas between two adjacent barrier walls 34 corresponding to X electrodes and Y electrodes. Note that such wider areas (i.e., the width of barrier wall 34 is relative narrow) may increase discharge space of discharge cells 41 and emissivity accordingly. The width of barrier wall 34 is increased from discharge cell 41 to non-discharge cell 42, i.e., the space of non-discharge cell 42 is small so as to serve as a gas channel between two adjacent discharge cells 41. This may concentrate energy released from gas discharge in discharge cells 41 within discharge cells 41 for increasing discharge efficiency, emissivity, avoiding undesired gas discharge, and achieving a smooth vacuum and gas filling during the manufacturing process of PDP.

In the embodiment, the width of barrier wall 34 is relative narrow at the position abutted discharge cell 41. Further, the width of barrier wall 34 is increased in a predetermined gradient from discharge cell 41 to non-discharge cell 42, i.e., the space of non-discharge cell 42 served as a gas channel between two adjacent discharge cells 41. Hence, it may increase opening of discharge cell. Also, the number of surface with phosphor layers coated is increased from typical three to seven. As a result, the coated area of phosphor layer is increased significantly and the emissivity of PDP is also improved.

In one configuration of above embodiment, the width of barrier wall 34 at the position abutted discharge cell 41 is increased in one of a plurality of predetermined gradients from discharge cell 41 to non-discharge cell 42, i.e., the space of non-discharge cell is small. Further, only one such non-discharge cell is reserved as a gas channel between two adjacent discharge cells 41.

In another configuration of above embodiment, the width of barrier wall 34 at the position abutted discharge cell 41 is increased in one of a plurality of predetermined arcs from discharge cell 41 to non-discharge cell 42, i.e., the space of non-discharge cell is small. Further, only one such non-discharge cell is reserved as a gas channel between two adjacent discharge cells 41.

As stated above, the width of one of plurality of parallel barrier walls 34 is relative wide at the position abutted non-discharge cell 42. Hence, the structural strength of barrier walls is greatly enhanced. In other words, the width of barrier wall 34 is relative narrow at the position abutted discharge cell 41. Hence, it may increase discharge space, avoid undesired gas discharge, and increase drive voltage in operation. Further, such increase of width of barrier wall 34 abutted non-discharge cell 42 may increase adhesion of dry photo-resist mold in the sputtering due to the increase of adhesive area of dry photo-resist mold. As a result, abnormal peeling of dry photo-resist mold is avoided in the sputtering and yield is increased significantly. Moreover, there is no need to alter the structure of front substrate 32 since only barrier walls 34 on back substrate 31 are modified. Hence, conventional drive technique for driving PDP is still applicable. As to printing on discharge cells 41 between adjacent barrier walls 34, the technique involved is substantially the same as that of conventional parallel barrier walls. Hence, the non-uniformity of phosphor layer printing and mixing of color as experienced in prior art is substantially eliminated. In addition, a black or opaque material may be used as cover of the barrier wall 34 abutted the non-discharge cell 2 in replacement of the producing of hatched region while preserving the feature of hatched region. As a result, the yield is increased greatly and the manufacturing cost is lowered significantly.

While the invention has been described by means of specific embodiments, numerous modifications and variations could be made thereto by those skilled in the art without departing from the scope and spirit of the invention set forth in the claims.

What is claimed is:

1. In an alternating current discharge type plasma display panel (PDP), a plurality of parallel barrier walls formed on top surface of a back substrate of said PDP, said barrier walls being disposed corresponding to cross-points of X electrodes and Y electrodes on a front substrate of said PDP, a structure comprising a plurality of discharge cells between said adjacent barrier walls having smaller width corresponding to said X and Y electrodes for forming a large first space, a plurality of non-discharge cells each between said adjacent discharge cells for forming a small second space served as a gas channel between said adjacent discharge cells, and a junction having a predetermined shape between one of the discharge cells and said adjacent non-discharge cell, whereby energy released from a gas discharge in said discharge cells is concentrated within said discharge cells.

2. The structure of claim 1, wherein said barrier wall abutted said non-discharge cell having a width increased in a predetermined gradient from said discharge cell to said adjacent non-discharge cell so that said adjacent non-discharge cell is served as said gas channel between said adjacent discharge cells.

3. The structure of claim 1, wherein said barrier wall abutted said non-discharge cell having a width increased in at least one predetermined gradient from said discharge cell to said adjacent non-discharge cell so that space of said non-discharge cell is reduced and only one of said non-discharge cells is served as said gas channel between said adjacent discharge cells.

4. The structure of claim 1, wherein said barrier wall abutted said non-discharge cell having a width increased in at least one predetermined arcs from said discharge cell to said adjacent non-discharge cell so that space of said non-discharge cell is reduced and only one of said non-discharge cells is served as said gas channel between said adjacent discharge cells.

5. The structure of claim 1, wherein cover of each barrier wall abutted said non-discharge cells is formed of an opaque material.
